(19) United States
(12) Patent Application Publication
(10) Pub. No.: US 2025/0121612 A1
(43) Pub. Date: Apr. 17, 2025

(54) SYSTEM FOR PRESERVING IMAGE QUALITY PRINTED ON A SUBSTRATE AND A METHOD FOR PRODUCING THE SAME

(71) Applicant: Xerox Corporation, Norwalk, CT (US)

(72) Inventors: Anthony S. Condello, Webster, NY (US); Varun Sambhy, Webster, NY (US); Patrick J. Howe, Faiport, NY (US); Eliud Robles Flores, Rochester, NY (US); Guo-Yau Lin, The Woodlands, TX (US)

(21) Appl. No.: 18/486,479

(22) Filed: Oct. 13, 2023

(51) Int. Cl. B41J 11/00; B41J 29/377; B41M 5/00; F25B 9/04

(52) U.S. Cl. CPC B41J 11/0015; B41J 11/007; B41J 29/377; B41M 5/0011; F25B 9/04

(57) ABSTRACT

An apparatus for preserving image quality printed on a substrate comprising a chilling device arranged to chill substrates moving proximate thereto, at least one marking material device, the marking material device arranged to form images on the substrates, and a media transport system configured to move the substrates past the chilling device and further configured to move the substrates past the at least one marking material device to form images on the substrates.

### FIELD OF THE INVENTION

The present invention relates generally to ink printing systems, and, more particularly, to an apparatus or system, and a method, for preserving the quality of images printed on substrates via either an aqueous or non-aqueous ink printing system.

### BACKGROUND

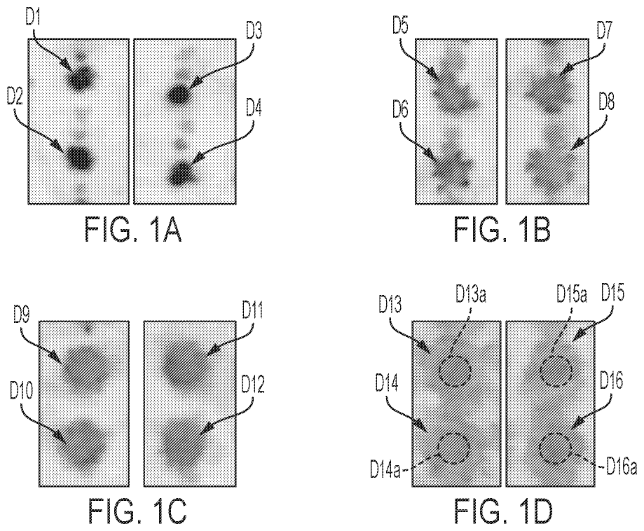

Typically, commercial printing systems apply a marking material, i.e., aqueous ink or non-aqueous ink, to a substrate, i.e., paper, at a “hot” temperature. The marking material is applied substantially as individual dots. The temperature of the marking material can range from 30°-40° C. at the time of application. The temperature of the marking material has a great effect on image quality applied to the substrate. The substrates are traditionally transported to a marking material device, i.e., at least one printhead or a printhead array, at room temperature, or an ambient temperature. When the marking material is applied to a substrate which is at ambient temperature, the individual dots of the marking material, i.e., the “hot” marking material, will initially spread out from its applied location on the substrate. However, the marking material will typically shrink back to a central point of application—thus decreasing the image quality of a final image on a particular substrate. See FIG. 1A.

In the art of commercial and/or residential printing, one possible solution is to cool the substrate prior to applying marking material to improve image quality—the individual dots of the marking material will spread out, or expand, after application, and will not shrink. This is desirable for improved image quality on a finalized substrate. See FIGS. 1B through 1D. However, many previous attempts to create these ideal conditions are conducted in substantially indirect manners, or the “cooling” of the substrate occurs post-marking material application, or cooling is done post-process through conduction; in other words, by directly touching a cooled physical component to a substrate post-printing. An example of a post-cooling method and/or system is described in U.S. Pat. No. 10,688,778, filed Sep. 11, 2018.

Another difficulty in preserving the final image quality of marking material on a substrate occurs when printing systems run a duplex path, where marking material (i.e., printing ink) is applied on both sides of a substrate. Typically, printing systems have a dryer arranged at a location after the marking material is applied to a first side of the substrate in the printing pathway. It is not uncommon for these dryers to increase the temperature of a substrate, where the heated substrate then enters the duplex pathway to receive marking material on its opposite side. Thusly, when the heated substrate arrives at the marking material device to receive marking material on its opposite side, the undesirable characteristics of applying marking material to an ambient temperature substrate, are amplified due to the heated substrate.

A further difficultly in preserving the final image quality of marking material on a substrate, specifically a substrate that is a coated paper, is that some coatings (e.g., polymers, kaolinite, calcium carbonate, bentonite, talc, chalk, china clay, etc.) of coated papers prevents marking material (e.g., ink) from being absorbed into the paper fibers, thus, when marking material is applied thereon, the marking material remains in a liquid form until it is dried, whereas marking material applied to coated paper immediately penetrates the paper fibers. The liquid marking material applied to coated paper has a tendency to move before it dries, leading to an increase in overlay graininess.

Thus, there is a long felt need for a system or apparatus, and/or method, for cooling a substrate prior to the substrate receiving marking material, in order to increase, improve or preserve final image quality on the substrate, on either a single side of the substrate, or on both sides of the substrate, i.e., in a duplex printing path.

It is also desirable to have a system or apparatus, and/or method, for cooling a substrate prior to the substrate receiving marking material, such that the cooled substrate increases the viscosity of marking material applied thereto-preventing the liquid marking material from excessively moving before drying and therefore improving overlay graininess of an image printed on the substrate.

### SUMMARY

A general object of the present invention, in various embodiments disclosed herein or within the scope of the inventive concept, is to provide a printing system and method, which improves a final image quality printed on a substrate, specifically by cooling or chilling the substrate prior to applying marking material, e.g., ink and the like, to the substrate.

The reference numerals provided within this section of the present disclosure are intended to put the present invention into context with the respective description and corresponding drawings. It should be noted that the reference numerals are merely exemplary and are not intended to be restrictive with respect to the scope of the appended claims.

The present invention, in one possible embodiment, generally a includes an apparatus, or system (100), for preserving image quality printed on a substrate (112), the apparatus or system (100) comprising a chilling device (120, 124, 140) arranged to chill substrates (112) moving proximate thereto, at least one marking material device (114), the marking material device (114) arranged to form images on the substrate (112), a media transport system (106) configured to move the substrate (112) past the chilling device (120, 124, 140) and further configured to move the substrate (112) past the at least one marking material device (114) to form images on the substrate (112).

The aforementioned chilling device (120, 124, 140) of the apparatus or system (100) may further include at least one vortex nozzle (128₁-128₇, 144).

Alternatively, the aforementioned chilling device (120, 124, 140) of the apparatus or system (100) may further include a vortex nozzle array (128), the vortex nozzle array (128) having a plurality of vortex nozzles (128₁-128₇).

In alternative arrangements, the aforementioned apparatus or system (100), when including at least one vortex nozzle (128₁-128₇, 144), may further comprise an air knife (142), the air knife (142) operatively arranged to direct a cold air stream (CAS) produced by the at least one vortex nozzle (128₁-128₇, 144) to the substrate (112).

In some embodiments, the aforementioned apparatus or system (100), when including at least one of: at least one vortex nozzle (128₁-128₇, 144); and, a vortex nozzle array (128), may further comprise an air baffle (130), the air baffle (130) operatively arranged to direct a cold air stream (CAS) produced by at least one of: the at least one vortex nozzle (128₁-128₇, 144); and, the vortex nozzle array (128), to the substrate (112).

In other arrangements, the aforementioned apparatus or system (100), when including at least one of: at least one vortex nozzle (128₁-128₇, 144); and, a vortex nozzle array (128), may further comprise at least one air compressor (126), the at least one air compressor (126) in fluid communication with at least one of: the at least one vortex nozzle (128₁-128₇, 144); and, the vortex nozzle array (128).

In further arrangements, the chilling device (120, 124, 140) of the aforementioned apparatus or system (100) comprises at least one chill-spray device (120), the chill-spray device (120) arranged to spray a chilling spray onto the substrates, i.e., a cold air stream (CAS).

In other embodiments, the aforementioned apparatus or system (100), when including at least one chill-spray device (120), the at least one chill-spray device (120) is in fluid communication with at least one chill-spray reservoir (126).

The present invention may also comprise a method for preserving the quality of an image printed on a substrate, the method comprising the steps of: 1) moving a substrate proximate a chilling device; 2) chilling the substrate with the chilling device, thereby creating a chilled substrate; 3) moving the chilled substrate proximate a marking material device; and, 4) printing marking material to form at least one image on the chilled substrate via the marking material device, thereby forming a substrate with marking material. In a preferred embodiment, the substrate is paper, although other substrates are possible and intended to be within the scope of the appended claims.

These and other objects, features, and advantages of the present invention will become readily apparent upon a review of the following detailed description of the invention, in view of the drawings and appended claims.

### BRIEF DESCRIPTION

Various embodiments are disclosed, by way of example only, with reference to the accompanying schematic drawings in which corresponding reference symbols indicate corresponding parts, in which:

FIGS. 1A through 1D generally illustrate individual dots applied to a substrate by the marking material device of the present invention;

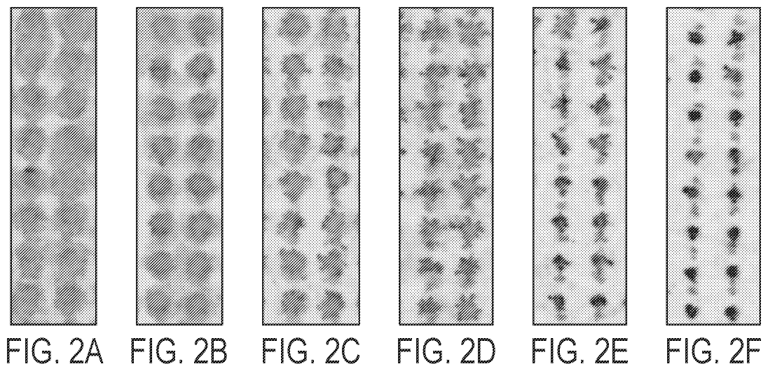

FIGS. 2A through 2F generally illustrate individual dots applied to a substrate by the marking material device of the present invention, specifically where the substrate is cooled below ambient temperature;

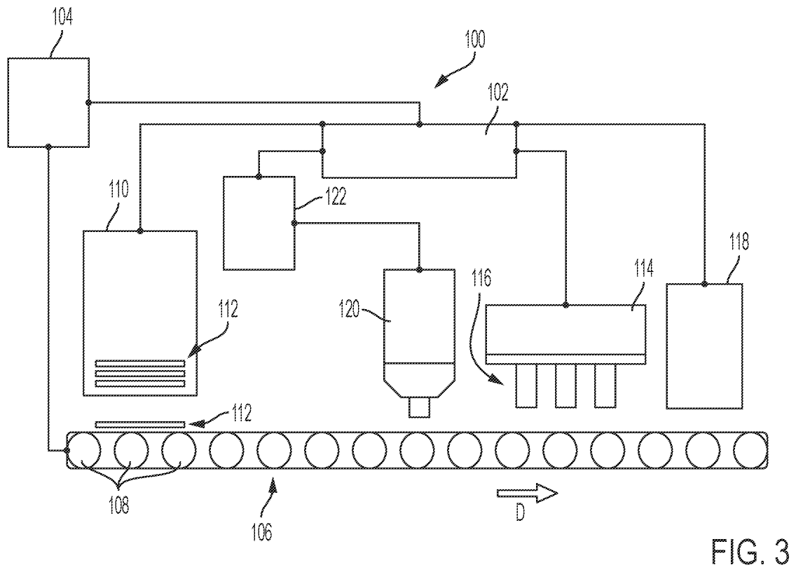

FIG. 3 generally illustrates a side view schematic diagram of an embodiment of the present invention;

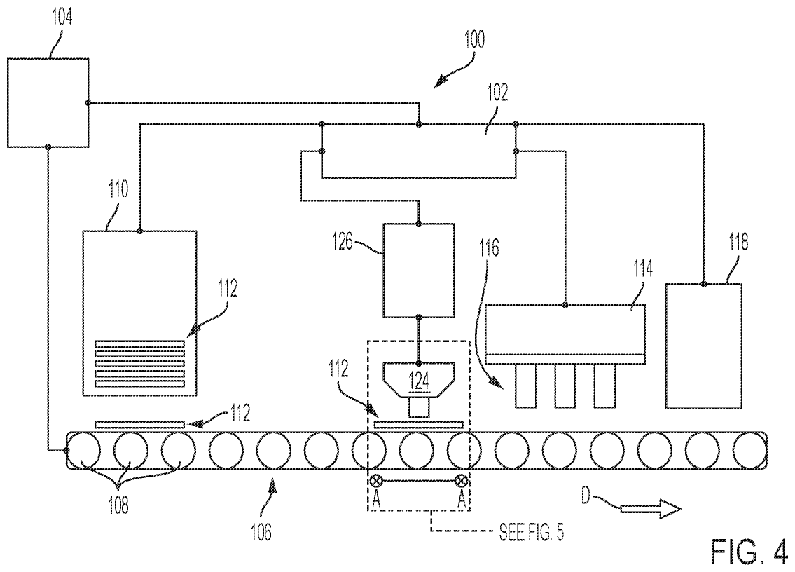

FIG. 4 generally illustrates a side view schematic diagram of a further embodiment of the invention shown in FIG. 3;

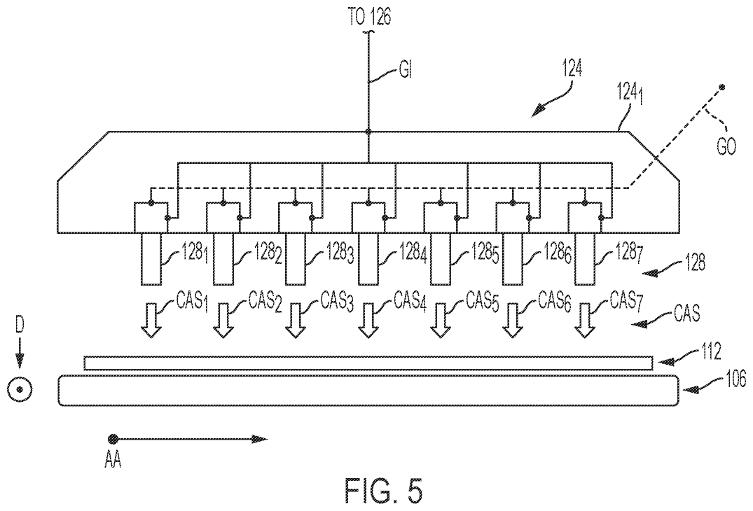

FIG. 5 shows an enlarged front view taken generally from perspective AA in FIG. 4;

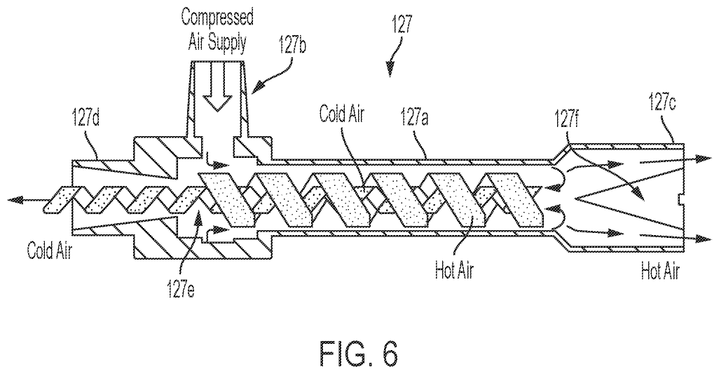

FIG. 6 illustrates a cross-sectional view of an embodiment of a vortex nozzle;

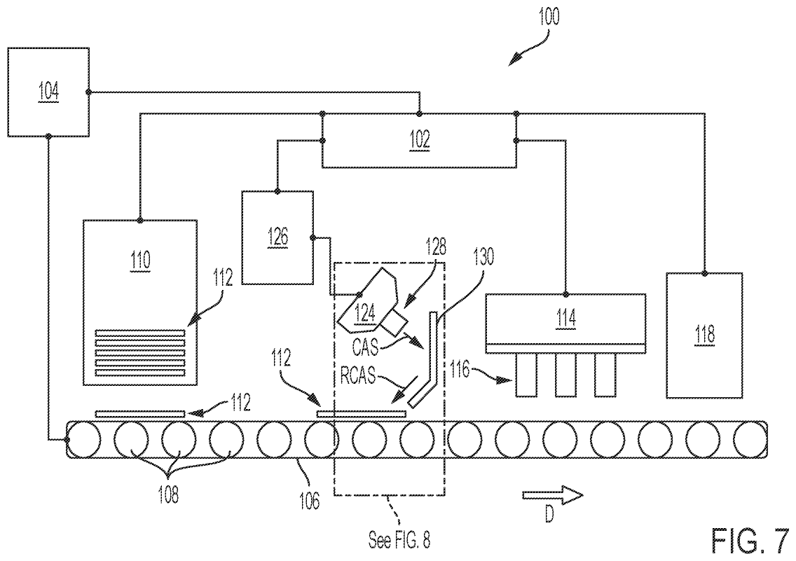

FIG. 7 generally illustrates a side view schematic diagram of a further embodiment of the invention shown in FIG. 4;

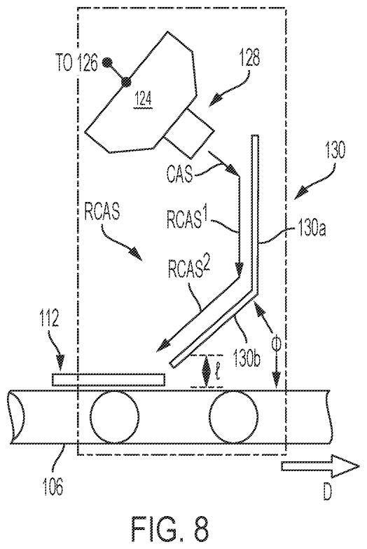

FIG. 8 shows an enlarged view taken generally from FIG. 7;

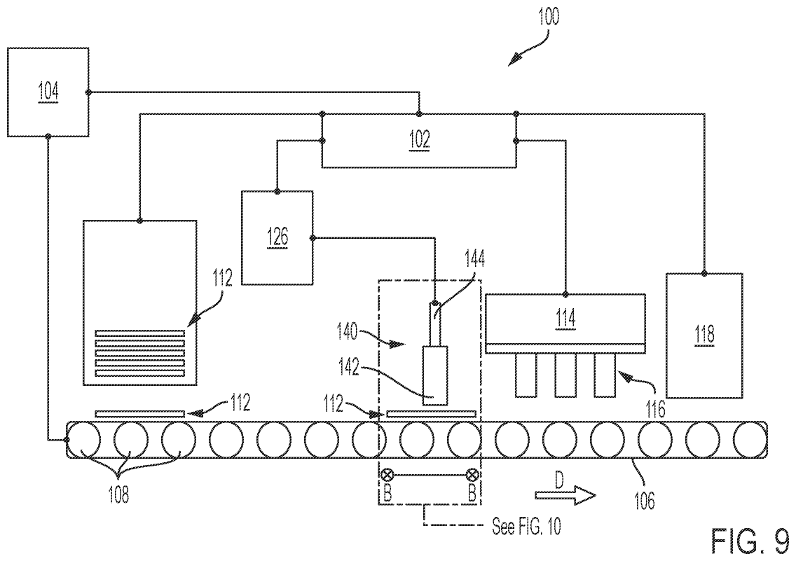

FIG. 9 generally illustrates a side view schematic diagram of a further embodiment of the invention shown in FIG. 4;

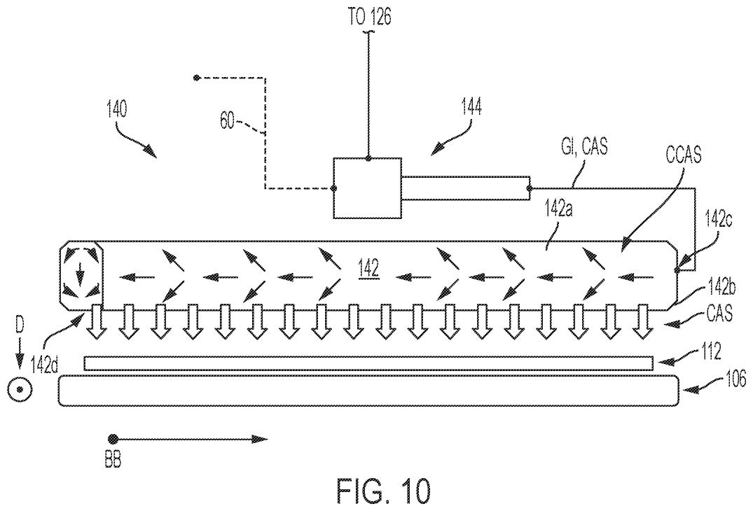

FIG. 10 shows an enlarged front view taken generally from perspective BB in FIG. 9;

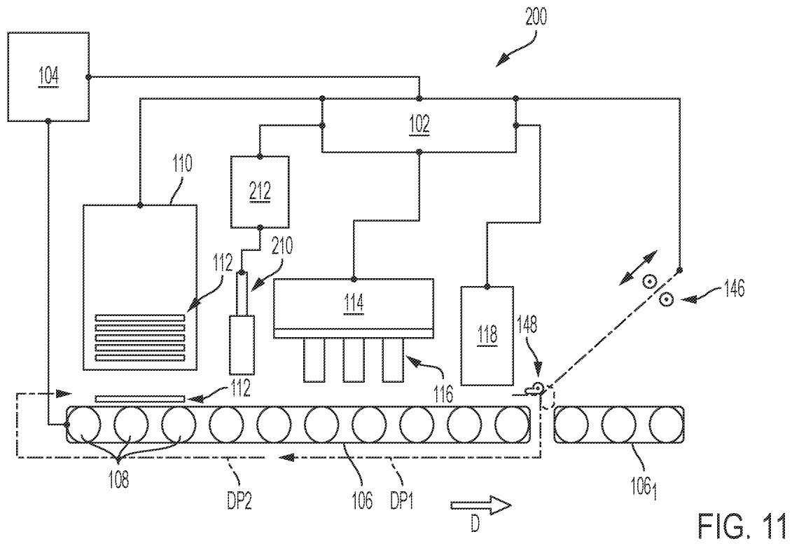

FIG. 11 generally illustrates a duplex embodiment of the invention shown in FIG. 4; and,

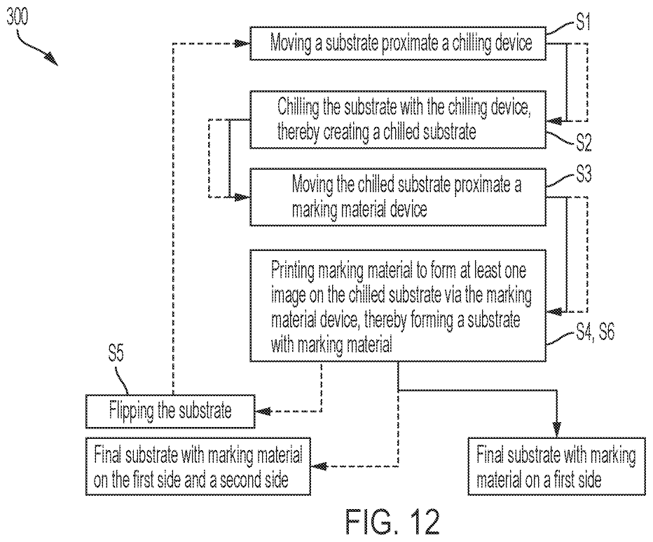

FIG. 12 generally illustrates a method of the present invention.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments. As such, those in the art will understand that any suitable material, now known or hereafter developed, may be used in forming the inventive concept described herein.

It should be noted that the terms “including”, “includes”, “having”, “has”, “contains”, and/or “containing”, should be interpreted as being substantially synonymous with the terms “comprising” and/or “comprises”.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that the use of “or” in the present application is with respect to a “non-exclusive” arrangement unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” or “one of:” is used herein.

Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

As described herein, the figures generally reference various embodiments of an aqueous printing system, system 100, that is configured to preserve image quality of printed substrates while drying aqueous ink images printed on the substrates. Although system 100 is preferably an aqueous printing system and is used to explain the structures and principles of operation of chilling device 120, chilling device 120 of this printer can be used in printers using other types of ink such as ink emulsions, inks made with other solvents, pigmented inks, ultraviolet (UV) curable inks, gel inks, solid inks, and the like and as well as printers that use toners and other marking materials to form images on substrates, such as xeroxgraphy. Thus, system 100 is a printing device capable of simplex or duplex output, in which a stream of images (or digital video signals representative of images) desired to be printed causes the desired images to be formed on a selected side of a print sheet or substrate, via a marking material device. As such, system 100 could also be a non-aqueous printing system. As used herein, the term “imaging system” means any system that forms images on substrates using any type of marking material, e.g., aqueous ink or non-aqueous ink, etc. Thus, while system 100 described below includes an ink printhead, or printhead array, other types of components can be used to form images with marking materials on the substrates. As used herein, the term “marking material device”, i.e., marking material device 114, means any device that applies a marking material, such as ink, toner, or the like, to a substrate to form an image on the substrate. As used herein, the term “dryer”, e.g., dryer 118, refers to a device that subjects printed images on substrates with a form of energy that removes a liquid or a solvent from the printed image. As used herein, “transport belt” or “media transport system”, e.g., transport belt 106, refers to a device arranged to “carry” or “move” substrates (e.g., paper, etc.) thereon, past and/or through various components of a printing system or printing device.

It should be noted that the aforementioned description of system 100 may also apply to system 200, described infra.

The following description should be taken in view of FIGS. 1A through 1D, which generally depict individual dots applied to a substrate by the marking material device of the present invention. Specifically, FIG. 1A illustrates individual dots of marking material D1 through D4 applied to a substrate, where the individual dots are applied at approximately 37° C. (or within the approximate range of 30 to 40° C.) to a substrate which is at ambient temperature (within the approximate range of 18 to 24° C.). As depicted, the individual dots of marking material are concentrated towards substantially central locations, shown by the darkness of the respective central locations. When individual dots of marking material are applied to the substrate, initially, the marking material expands from an application location, however, the temperature combination of the ambient temperature substrate and the “hot” marking material causes the expanded material to relax, or shrink back, to the original central location-thus decreasing final image quality on the substrate.

FIGS. 1B through 1D generally illustrate individual dots applied to a substrate by the marking material device of the present invention (individual dots D5 through D16), specifically where the substrate is cooled below ambient temperature, progressively colder from FIGS. 1B to 1D, i.e., the substrate shown in FIG. 1D is colder than the substrate shown in FIG. 1B. Instead of the individual dots of marking material expanding then shrinking (as shown in FIG. 1A, individual dots D1 through D4), individual dots D5 through D16 of marking material expand after application on the substrate and remain expanded, whereas FIG. 1D shows the substrate at a cold enough temperature where a greater quantity of marking material remains at the substantially central application location, i.e., individual dots D13 through D16. Individual dots D13 through D16 have a darker substantially central location, i.e., a “nucleus” (nuclei D13a through D16a), due to the marking material immediately freezing, or substantially freezing upon application-limiting the expansion of the individual dots of marking material.

The following description should be taken in view of FIGS. 2A through 2F which generally illustrate individual dots of marking material applied to a substrate by the marking material device of the present invention, where the substrate is subjected to cooling by the chilling device of the present invention, described further, infra. The marking material shown in the aforementioned figures is applied to the substrate at approximately 37° C. (or within the approximate range of 30° to 40° C.). FIG. 2A generally illustrates a plurality of dots of marking material applied to a substrate that has been chilled or cooled to approximately −5° to 0° C. FIG. 2B generally illustrates a plurality of dots of marking material applied to a substrate that has been chilled or cooled to approximately 1° to 7° C. FIG. 2C generally illustrates a plurality of dots of marking material applied to a substrate that has been chilled or cooled to approximately 8° to 11° C. FIG. 2D generally illustrates a plurality of dots of marking material applied to a substrate that has been chilled or cooled to approximately 12° to 14° C. FIG. 2E generally illustrates a plurality of dots of marking material applied to a substrate that has been chilled or cooled to approximately 15° to 19° C. FIG. 2F generally illustrates a plurality of dots of marking material applied to a substrate that has been chilled or cooled to approximately 20° to 24° C. As such, the chilling device of the present invention aims to produce individual dots of marking material at the temperature ranges, and respective marking material spreads, illustrated in FIGS. 2A through 2D, e.g., substantially similar to individual dots D5 through D16 in FIGS. 1B through 1D, however it should be noted that these preferences are merely exemplary and not intended to be restrictive on the scope of the appending claims.

As generally illustrated in FIGS. 1A through 2F, particularly FIGS. 2A and 2D, chilling a substrate prior to the application of marking material (e.g., ink and the like), improves ink spread on coated paper (i.e., coated substrates), as coated paper typically does not allow for applied ink to spread completely. However, when a substrate is chilled prior to ink application, the ink viscosity increases (due to the cooling) and therefore prevents the ink from retracting back, i.e., the ink remains spread on the substrate, while also preventing the liquid from excessively moving before drying-improving overlay graininess on a final printing image. Therefore, the present invention provides for the ideal temperatures to lock the ink, as applied to a chilled substrate, as “fully spread” upon impact with the chilled substrate-which also makes the circular size and shape of the individual ink drops more uniform.

It should be appreciated that the preferred temperature of a substrate, applied by the present invention, is at or within the approximate range of −5° to 5° C., however, an acceptable temperature range is at or within the approximate range of −10° C. to 20° C.

FIG. 3 generally illustrates a schematic diagram of an embodiment of the present invention, system 100. System 100 can take various forms of known-in-the-art printing systems and includes, at least, controller 102, or one or more controllers. It should be noted that controller 102 may take a variety of forms such that it is able to operate the various additional components of system 102, such as two or more controllers or other logic units, processors, or the like, which can be used to operate at least one of actuator 104, chilling device support 122, chilling device 120, marking material device 114, and dryer 118, separately and independently with different controllers communicating with one another to synchronize the operation of these components. Controller 102 may also be arranged to deliver power to any of the aforementioned components.

In some embodiments, system 100 includes actuator 104 which is in communication with controller 102. Actuator 104 is arranged to drive transport belt 106, specifically, actuator drives one or more of plurality of rollers 108. Transport belt 106 may be configured as an endless belt configured about two or more of plurality of rollers 108, whereas at least one roller of plurality of rollers 108 is driven by actuator 104 that is operated by controller 102 to rotate transport belt 106 about the rollers to move substrates, e.g., at least one of substrate 112 thereon.

Controller 102 may also be in communication with substrate tray 110 having substrates 112 therein. Substrate tray 110 may be a housing, holder, etc. that contains substrates 112 therein and is arranged to place individual substrates on transport belt 106 for movement thereon, where controller 102 may be arranged to control the release of individual substrates onto transport belt 106.

Marking material device 114 includes printhead array 116, where marking material device 114 (and printhead array 116) are operated by controller 102 in a known manner to eject drops of aqueous ink, or other ink types, onto the substrates passing by them to form images on the substrates passing on transport belt 106.

In some arrangements, system 100 may include dryer 118 which may be in communication with controller 102 and is configured with energy emitting devices that remove water, or other solvents from a printed image on a substrate, as recited supra.

As described supra, the primary object of the present invention, system 100, is to preserve the quality of an image printed on a substrate, namely by cooling, or chilling, a substrate prior to printhead array 116 of marking material device 114 via chilling device 120. As shown in FIGS. 1B through 2D, cooling a substrate, prior to the application of marking material from printhead array 116, improves the spread of each individual dot of marking material applied to a substrate, i.e., improves the individual dot of marking material quality when applied to a substrate. As such, chilling device 120 may be arranged to be indirect communication with at least one of: chilling device support 122, controller 102, or a combination thereof.

In some embodiments, chilling device 120 may comprise a device arranged to apply a freeze spray directly to a substrate passing on transport belt 106, prior to the substrate receiving marking material from marking material device 114. The freeze spray (or cold spray or vapocoolant) applied by chilling device may be a type of aerosol spray product containing a liquified gas used for rapidly cooling surfaces. The freeze spray could be a combination of tetrafluoroethane, dimethyl ether, gas dusters, liquified petroleum such as propane or butane, chloroethane, liquid nitrogen, a gas similar to a carbon dioxide fire extinguisher, or other like substance having similar cooling or chilling characteristics.

In some arrangements, system 100 may also include chilling device support 122, which may be in communication with at least one of: controller 102 and chilling device 120. Chilling device support 122 may be a storage reservoir, or tank, arranged to hold freeze spray, fluidly communicating the freeze spray to chilling device 120 for application. Chilling device support 122 may be arranged with sensors to communicate levels of freeze spray to controller 102.

Chilling device 120 may comprise a nozzle, spray applicator, a plurality thereof, or a combination thereof, to deliver freeze spray onto a substrate in either a direct location (from a single nozzle or spray applicator) or a plurality of direct locations (from a plurality of nozzles or spray applicators), as a substrate travels past chilling device 120 on transport belt 106, thereby cooling or chilling each substrate within the approximate range of −10° C. to 20° C., preferably within the approximate range of −5° C. to 5° C., prior to, or just before, the respective substrate receiving marking material from printhead array 116 of marking material device 114, such that the respective substrate is a chilled substrate.

The following description should be taken in view of the aforementioned figures, and FIGS. 4 and 5. FIG. 4 illustrates another embodiment of system 100 of the present invention, having all of the components of system 100 shown in FIG. 3, except for chilling device 120 and chilling device support 122. In some embodiments, system 100 may instead include chilling device 124 and chilling device support 126, where chilling device 124 may be in communication with at least one of: controller 102 and chilling device support 126 and chilling device support 126 may be in communication with at least one of: controller 102 and chilling device 124.

In alternative arrangements of system 100, chilling device 124 may comprise at least one vortex tube, or a plurality of vortex tubes (vortex nozzle array 128), where chilling device 124 may comprise at least one of: housing 1241 arranged to hold vortex nozzle array 128; and vortex nozzle array 128. In some embodiments, vortex nozzle array 128 may comprise vortex nozzles 128₁-128₇. In other embodiments, vortex nozzle array 128 may comprise various combinations of vortex nozzles, e.g., 6×2 vortex nozzles, 4×3 vortex nozzles, 4×4 vortex nozzles, etc. In further arrangements, vortex nozzle array 128 may comprise a combination of vortex nozzles arranged such that each cold air stream produced by each vortex nozzle overlaps, potentially eliminating non-uniform cooling of a substrate i.e., cooling that produces cold spots or spot cooling on the substrate.

It should be noted that the terms “vortex tube” and “vortex nozzle” are intended to be substantially synonymous. A vortex tube or vortex nozzle is known in the art, and is also known as Ranque-Hilsch vortex tube, which is a mechanical device that separates a compressed/pressurized gas into hot and cold streams. The gas emerging from the hot end can reach temperatures of 200° C., and the gas emerging from the cold end can reach −50° C. These tubes have no moving parts and are considered an environmentally friendly technology because they work solely on compressed air that is fed into the tube. In use, pressurized gas is injected tangentially into a “swirl chamber” or “vortex spin chamber” near one end of a tube, leading to a rapid rotation—the first vortex—as it moves along the inner surface of the tube to the far end. A conical nozzle allows gas specifically from this outer layer to escape at that end through a valve. The remainder of the gas is forced to return in an inner vortex of reduced diameter within the outer vortex. Gas from the inner vortex transfers heat to the gas in the outer vortex, so the outer layer is hotter at the far end than it was initially. The gas in the central vortex is likewise cooler upon its return to the starting-point, where it is released from the tube.

As such, chilling device support 126 may comprise an air compressor, or air compressor supply, which is in communication with chilling device 124 and therefore, in communication with vortex nozzle array 128 to provide the aforementioned compressed and/or pressurized gas, via gas input GI, to each vortex nozzle (128₁-128₇) of vortex nozzle array 128. Vortex nozzles 128₁-128₇ each have a gas output line which collectively feed to gas output GO. Each of the gas outputs of Vortex nozzles 128₁-128₇ are arranged substantially proximate to each respective gas input from gas input GI, i.e., gas input GI feeds to each of nozzles 128₁-128₇.

A possible embodiment of one vortex nozzle (e.g., vortex nozzle 127) of vortex nozzle array 128 is illustrated in FIG. 6. In some embodiments, vortex nozzle 127 may comprise main tube 127a disposed between and in fluid communication with airflow inlet 127b, hot airflow outlet 127c, cold airflow outlet 127d. Control valve 127f is arranged within and proximate hot airflow outlet 127c and is arranged to control the rate of the hot air flow from hot airflow outlet 127c. Vortex spin chamber 127e is arranged proximate airflow inlet 127b and cold airflow outlet 127d-compressed air entering airflow inlet 127b and into vortex spin chamber 127e and main tube 127a rotates around a central axis thereof, thereby expanding the compressed and cooling it. After the energy separation inside main tube 127a and spin chamber 127e, the input compressed air is divided into two streams (hot and cold) with large temperature difference. The first output, also known as “cold exhaust”, exits from cold airflow outlet 127d. The second output, also known as “hot exhaust” exits from hot airflow outlet 127c, proximate control valve 127f. Opening control valve 127f leads to an increase in the flow rate at the hot exhaust, consequently, the cold air flow is reduced.

As shown in FIG. 5, vortex nozzle array 128 is positioned above transport belt 106 and each vortex nozzle of vortex nozzle array 128 has an output end that is directed at transport belt 106. When system 100 is in operation, substrate 112 travels on transport belt 106 in direction D, i.e., from substrate tray 110 towards dryer 118. While substrate 112 travels the aforementioned path, it passes underneath each vortex nozzle of vortex nozzle array 128, where vortex nozzle array 128 directly feeds cold air stream CAS (i.e., each of vortex nozzles 128₁-128₇ feed cold air streams CAS₁-CAS₇, respectively) onto each of the substrates that pass underneath, cooling each of the substrates (within the approximate range of −10° C. to 20° C., preferably below approximately 10° C., and more preferably −5° C. to 5° C.), prior to the respective substrates arriving at marking material device 114 to receive marking material from printhead array 116. This arrangement of components of the embodiment of system 100 shown in FIG. 4, achieves the most desirable final image quality (through the temperature change applied to each substrate via chilling device 124), as discussed supra in view of FIGS. 1A through 2F.

The following description should be taken in view of FIGS. 4 through 8, where FIGS. 7 and 8 each illustrate schematic diagrams of alternative embodiments of system 100 shown in FIG. 4.

FIG. 7 illustrates another embodiment of system 100 of the present invention, having all of the components of system 100 shown in FIG. 4, with the addition of air baffle 130 and a possible positional rearrangement of chilling device 124. In the shown embodiment of system 100, chilling device 124 (and vortex nozzle array 128) are angled in a direction towards air baffle 130. In the embodiment of system 100 shown in FIG. 4, cold air stream CAS (cold air streams CAS₁-CAS₇ of each of vortex nozzles 128₁-128₇) can produce localized cooling non-uniformities (i.e., spot cooling) that may arise from the directed air from individual nozzles (vortex nozzles 128₁-128₇) hitting a substrate directly-if there is not a sufficient number of vortex nozzles arranged within vortex nozzle array 128 (to create a more uniform cold air stream CAS). To minimize, or eliminate, potential cold spots, in the embodiment of system 100 shown in FIG. 7, chilling device 124 may be angled such that cold air stream CAS is directed to air baffle 130, which in turn redirects and unifies the cold air stream, i.e., redirected cold air stream RCAS, before the cold air stream hits substrate 112 on transport belt 106. As such, air baffle 130 may be arranged to have an angled bend proximate transport belt 106 to redirect cold air stream CAS in a direction towards transport belt 106, or air baffle 130 could be substantially planar (no bends) and vortex nozzle array 128 of chilling device 124 could be arranged in an angled position to feed cold air stream CAS to air baffle 130 such that air baffle 130 produces redirected cold air stream RCAS onto a substrate below.

In reference to FIG. 8, which generally illustrates an enlarged portion of FIG. 7, specifically, air baffle 130. In some embodiments, air baffle 130 comprises longitudinal portion 130a proximate vortex nozzle array 128 and angled portion 130b proximate transport belt 106. In some embodiments, longitudinal portion 130a is substantially perpendicular to transport belt 106 and angled portion 130b (extending from longitudinal portion 130a) is arranged at angle φ (approximately 24°-51°) with respect to transport belt 106. In a preferred embodiment, the end of angled portion 130b is arranged at length l (approximately 2 mm-10 mm) from a top surface of substrate 112 on transport belt 106. In a preferred embodiment, air baffle 130 is comprised of angled sheet metal, however those in the art will understand that any suitable material, now known or hereafter developed, may be used in forming air baffle 130. As generally shown, redirected cold air stream RCAS includes first redirected cold air stream RCAS¹ and second redirected cold air stream RCAS², where longitudinal portion 130a produces first redirected cold air stream RCAS¹ and angled portion 130b produces second redirected cold air stream RCAS², such that second redirected cold air stream RCAS² is generally arranged in an opposite direction of direction D (the direction of substrates traveling on transport belt 106).

The following description should be taken in view of FIGS. 9 and 10. FIG. 9 illustrates a further embodiment of system 100 of the present invention, having all of the components of system 100 shown in FIG. 4, but instead includes chilling device 140 (instead of chilling device 124) with the addition of at least one air knife, air knife 142. Like the embodiment of system 100 shown in FIG. 7, the embodiment of system 100 in FIG. 9 aims to prevent localized cooling non-uniformities (i.e., spot cooling) on a substrate passing underneath chilling device when the substrate is subjected to a cold air stream from chilling device 140.

Air knife 142 refers to a tool typically used to blow off liquid or debris from products as they travel on conveyors, or transport belts. Air knives are normally used in manufacturing or as the first step in a recursive recycling process to separate lighter or smaller particles from other components for use in later or subsequent steps, post manufacturing parts drying and conveyor cleaning, part of component cleaning, or delivering a substantially-uniform stream of air, or to cool down a product's surface. An air knife consists of a high-intensity, uniform sheet of laminar airflow sometimes known as streamline flow.

In some embodiments of air knife 142, the air knife is a pressurized air plenum containing a series of holes or continuous slots through which pressurized air exits in a laminar flow pattern. The exit air then impacts the surface of whatever object it is directed to. The exit air impacts the surface at an impact velocity, which can range from a gentle breeze to greater than approximately Mach 0.6 (40,000 ft/min) to alter the surface of a product without mechanical contact.

In the embodiment of system 100 shown in FIG. 9, air knife 142 is fed a cold air stream from at least one vortex nozzle, vortex nozzle 144, where chilling device support 126 feeds compressed air to vortex nozzle 144. As shown in FIG. 10, which generally shows an enlarged front view (a portion thereof) taken generally from perspective BB in FIG. 10, air knife 142 creates a uniform cold air stream CAS onto substrate 112 traveling on transport belt 106. Vortex nozzle 144 outputs gas input GI, which is also cold air stream CAS, into air knife 142, where air knife 142 uniformly delivers cold air stream CAS to substrate 112, prior to substrate 112 receiving marking material from printhead array 116 of marking material device 114. Vortex nozzle 144 also includes gas output GO, which outputs heated gas from vortex nozzle 144, i.e., an exhaust. In some embodiments, air knife 142 includes plenum chamber 142a, knife edge 142b having plurality of outflow apertures 142d therein, and inlet 142c. As described supra, cold air stream CAS is fed to inlet 142c from vortex nozzle 144, where plenum chamber 142a creates circulating cold air stream CCAS therein, which is fed through each of plurality of outflow apertures 142a as homogenized cold air stream CAS onto substrate 112.

FIG. 11 generally illustrates a schematic diagram of another embodiment of the present invention, duplex system 200. It should be appreciated that duplex system 200 generally includes all of the components of the previously described embodiments of system 100. However, system 200 includes chilling device 210 and chilling device support 212, whereas chilling device 210 may comprise any of the aforementioned combinations of the previously described chilling devices (including the addition of an air baffle and/or air knife), and chilling device support 210 may comprise any of the aforementioned combination of the previously described chilling device supports. System 200 includes transport belt 106, which includes a duplex loop or duplex path, generally designated by DP1 and DP2, and end portion 1061 of transport belt 106, where the duplex loop is a portion of transport belt 106 arranged in front of, i.e., before in relation to direction D, end portion 1061.

To create a duplex print (e.g., duplex paths DP1 and DP2, or “loop”), that is, a substrate having marking material on one side thereof and marking material on the other side thereof, it is necessary to make the other side of the substrate available to print head array 116 of marking material device 114, by causing the other side of the substrate to face outward while substrate 112 travels on transport belt 106. As such, first duplex pathway DP1 and second duplex pathway DP2 represent a looped portion of transport belt 106, or a duplex pathway. As such, in some embodiment of system 200, transport belt 106, specifically within the duplex pathway (i.e., DP1 and/or DP2) may comprise an inverter operatively arranged along the “loop” (referring to transport belt 106 and duplex pathways DP1 and DP2 of the transport belt). In some embodiments, inverter 146 is operatively arranged to remove a substrate from the loop (i.e., DP1 and/or DP2) which comprises marking material (i.e., a finalized image) already arranged on the outward-facing side thereof, and turn the substrate over so that the other, “non-printed”, or “non-marking material”, side of the sheet faces outward from a portion of transport belt 106 within the loop. Thus, the inverter removes the substrate from the loop, feeding it in one direction, and then delivering the substrate back to the loop to turn the sheet over (i.e., invert the sheet 180° and shown). The loop then re-feeds the substrate for another cycle so that printhead array 116 of marking device 114 can place marking material on the other side thereof. In some arrangements gate 148 may be arranged next to inverter 146 to selectably cause the substrate to enter the inverter, depending on whether the particular substrate passing thereby is a simplex print (determined by controller 102), the first side of a duplex print (determined by controller 102), or a second side of a duplex print (determined by controller 102). As shown in FIG. 9, after a first side of the substrate is printed, controller 102 instructs gate 148 to pick of the substrate such that it may be inverted (flipped) by inverter 146 and then placed back on the loop (i.e., back on transport belt 106) to receive marking material from print head array 116 of marking material device 114 on the unprinted side thereof. It should be noted that the aforementioned description of a duplex print of system 200 is merely exemplary, as alternatives are disclosed in U.S. Pat. No. 11,604,612 and U.S. Published Patent Application No. 2023/0153040, and are known within the art of printing devices.

Thusly, system 200 may cool substrate twice, i.e., before marking material is applied to a first side of substrate 112 and before marking material is applied to a second side of substrate 112 after substrate 112 exits duplex paths DP1 and DP2, is flipped, and is carried a second time on transport belt 106, via inverter 146. After substrate 112 receives marking material on both of its respective sides, substrate 112 is carried to end portion 1061, where it may be stacked via a stacking device, removed from system 200, etc. It should be appreciated that in some embodiments of system 200, dryer 118 is arranged after marking material device 114 in relation to direction D. Therefore, substrate 112 that is arranged for a duplex print, is subjected to the heat of marking material applied by printhead array 116 of marking material device 114 and may also be subjected to heat from dryer 118. Once substrate 112 enters duplex paths DP1 and DP2, the ambient temperature within system 200 will cool substrate 112, but not enough to achieve the desirable temperatures recited supra. Chilling device 210 not only cools substrate 112 prior to the first application of marking material on the first side of substrate 112, but also cools substrate 112 after being exposed to dryer 118 and “hot” marking material from marking material device 114, allowing substrate 112 to be cooled to the desired temperature prior to the second application of marking material on the second side of substrate 112. Thus, chilling device 210, in system 200, during a duplex printing, directly cools, via a cold airstream, both sides of substrate 112.

The following description should be interpreted in consideration of all of the aforementioned figures and FIG. 12. FIG. 12 generally illustrates a method for preserving image quality printed on a substrate, method 300, which may be executed by any of the embodiments of systems 100 and 200, or combinations thereof, described supra. In some embodiments, method 300 may comprises the steps of:
S1) moving a substrate (112) proximate a chilling device (120, 124, 140, 200);
S2) chilling the substrate (112) with the chilling device (120, 124, 140, 200), thereby creating a chilled substrate (112);
S3) moving the chilled substrate (112) proximate a marking material device (114); and,
S4) printing marking material to form at least one image on the chilled substrate (112) via the marking material device (114), thereby forming a substrate with marking material.

In other embodiments, method 300 may be a method for preserving image quality printed on a first and second side of a substrate (i.e., a method for preserving image quality for a duplex print on a substrate), method 300 may comprise the steps of: S1) moving a substrate (112) proximate a chilling device (120, 124, 140, 200); S2) chilling the substrate (112) with the chilling device (120, 124, 140, 200), thereby creating a chilled substrate (112); S3) moving the chilled substrate (112) proximate a marking material device (114); S4) printing marking material to form at least one image on the chilled substrate (112) via the marking material device (114), thereby forming a substrate with marking material on a first side of the substrate (112); S5) flipping the substrate (112); and, S6) repeating steps S1 through S3 and printing marking material to form at least one image on the second side of the chilled substrate via the marking material device (114), thereby forming a substrate with marking material on the first and the second side of the substrate (112).

In all of the aforementioned embodiments, it is preferable that the chilling device of the present invention applies a cold air stream to a substrate approximately 0.5-5 seconds before the substrate receives marking material, preferably 1-2 seconds.

It should be appreciated that all of the aforementioned embodiments of the chilling device not only cool a substrate prior to the substrate receiving marking material thereon, the cold air stream applied thereto (approximately −10° C. to 20° C., preferably approximately −5° C. to 5° C.) creates a transient thin layer of ice on the substrate (from ambient humidity within the printing devices and/or present on or within the particular substrate). The aforementioned ice layer can change the properties of the substrate (surface energy, chemistry, and/or paper morphology) to enable better spread of ink and improved overlay graininess. The aforementioned ice layer, when applied to uncoated paper, gives the uncoated paper similar properties to coated paper via the ice layer (i.e., making the uncoated paper less porous due to the ice layer).

As such, the shown and described embodiments are merely exemplary and various alternatives, combinations, omissions, of specific components, or foreseeable alternative components, understood by one having ordinary skill in the art, described in the present disclosure or within the field of the present disclosure, are intended to fall within the scope of the appending claims.

It should be noted that the present invention, in its various embodiments, described herein or foreseeable within the scope of the inventive concept, relates to printing devices and/or methods of printing. As such, one having ordinary skill in the art should interpret the terminology in view of the same. Exemplary individuals having said ordinary skill in the art include, but are not limited to, employees, engineers, designers, of well-known companies, such as, but not limited to, Xerox®.

It will be appreciated that various aspects of the inventive concept and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### CITATIONS

The following references are incorporated herein by reference in their entireties:
1. U.S. Pat. No. 10,688,778, filed Jun. 23, 2020;
2. U.S. Pat. No. 11,604,612, filed Sep. 21, 2021; and,
3. U.S. Published Patent Application No. 2023/0153040, filed Nov. 17, 2021.

### REFERENCE NUMERALS

100 System
102 Controller
104 Actuator
106 Transport belt
106₁ End portion of 106
108 Plurality of rollers
110 Substrate tray
112 Substrate
114 Marking material device
116 Printhead array
118 Dryer
120 Chilling device
122 Chilling device support
124 Chilling device
1241 Housing
126 Chilling device support
127 Vortex Nozzle
127a Main tube
127b Airflow inlet
127c Hot airflow outlet
127d Cold airflow outlet
127e Vortex spin chamber
127f Control valve
128 Vortex nozzle array
128₁ First vortex nozzle
1282 Second vortex nozzle
128₃ Third vortex nozzle
128₄ Fourth vortex nozzle
128₅ Fifth vortex nozzle
128₆ Sixth vortex nozzle
128₇ Seventh vortex nozzle
130 Air baffle
130a Longitudinal portion
130b Angled portion
140 Chilling device
142 Air knife
142a Plenum chamber
142b Knife edge
142c Inlet
142d Outflow apertures
144 Vortex nozzle
146 Inverter
148 Gate
200 Duplex system
210 Chilling device
212 Chilling device support
CAS Cold air stream
CAS₁ First cold air stream
CAS₂ Second cold air stream
CAS₃ Third cold air stream
CAS₄ Fourth cold air stream
CAS₅ Fifth cold air stream
CAS₆ Sixth cold air stream
CAS₇ Seventh cold air stream
CCAS Circulating cold air stream
D Direction
D1-D16 Individual dots of marking material
D13a-D16a Individual nucleus
DP1 First duplex pathway
DP2 Second duplex pathway
GI Gas input
GO Gas output
RCAS Redirected cold air stream
RCAS¹ First redirected cold air stream
RCAS² Second redirected cold air stream
l Length
φ Angle

What is claimed is:

1. A method for printing an image on a substrate, the method comprising the steps of:
1. moving a substrate proximate a chilling device;
2. chilling the substrate with the chilling device, thereby creating a chilled substrate;
3. moving the chilled substrate proximate a marking material device; and,
4. printing marking material to form at least one image on the chilled substrate via the marking material device, thereby forming a substrate with marking material.

2. The method recited in claim 1, wherein said chilling device is at least one vortex nozzle, wherein said substrate in step 2) is chilled by the at least one vortex nozzle to approximately −5° C. to 5° C.

3. The method recited in claim 2, wherein: said substrate is a non-coated paper; and, the marking material is aqueous ink.

4. The method recited in claim 3, wherein step 2) prevents retraction of a spreading of said marking material in step 4) on said substrate with marking material.

5. The method recited in claim 3, wherein said non-coated paper becomes less porous from said chilling in step 2).

6. The method recited in claim 2 further comprising:
2a) forming a thin layer of ice on said substrate from at least one of:
ambient humidity; and,
moisture on or within said substrate.

7. The method recited in claim 2, wherein the at least one vortex nozzle comprises:
at least one vortex tube; and,
at least one of:
an air knife; and,
an air baffle.

8. The method recited in claim 2, wherein the hot substrate is indirectly chilled by the at least one vortex nozzle.

9. The method recited in claim 8 further comprising:
redirecting a chilled air stream produced by the at least one vortex nozzle via a redirecting device, the redirecting device arranged to directly receive the chilled air stream and redirect the chilled air stream onto the hot substrate.

10. An apparatus for printing an image on a substrate, comprising:
a chilling device arranged to chill substrates moving proximate thereto;
at least one marking material device, the marking material device arranged to form images on the substrates; and,
a media transport system configured to move the substrates past the chilling device and further configured to move the substrates past the at least one marking material device to form images on the substrates.

11. The apparatus for printing an image on a substrate recited in claim 10, wherein the chilling device comprises:
at least one vortex nozzle.

12. The apparatus for printing an image on a substrate recited in claim 10, wherein the chilling device comprises:
a vortex nozzle array, the vortex tube array having a plurality of vortex nozzles.

13. The apparatus for printing an image on a substrate recited in claim 11 further comprising an air knife, the air knife operative arranged to direct a cold air stream produced by the at least one vortex nozzle to the substrates.

14. The apparatus for printing an image on a substrate recited in claim 11 further comprising an air baffle, the air baffle operative arranged to direct a cold air stream produced by the at least one vortex nozzle to the substrates.

15. The apparatus for printing an image on a substrate recited in claim 11 further comprising an air knife, the air knife operative arranged to direct a cold air stream produced by the vortex nozzle array to the substrates.

16. The apparatus for printing an image on a substrate recited in claim 12 further comprising an air baffle, the air baffle operative arranged to direct a cold air stream produced by the vortex nozzle array to the substrates.

17. The apparatus for printing an image on a substrate recited in claim 10, wherein the chilling device is arranged to feed a cold air stream onto the substrates.

18. The apparatus for printing an image on a substrate recited in claim 10, wherein the chilling device comprises:
at least one chill-spray device, the chill-spray device arranged to spray a chilling spray onto the substrates.

19. The apparatus for printing an image on a substrate recited in claim 18, wherein the at least one chill-spray device is in fluid communication with at least one chill-spray reservoir.

20. The apparatus for printing an image on a substrate recited in claim 11 further comprising at least one air compressor, the at least one air compressor in fluid communication with the at least one vortex nozzle.

21. The apparatus for printing an image on a substrate recited in claim 12 further comprising at least one air compressor, the at least one air compressor in fluid communication with each vortex nozzle of the vortex nozzle array.

22. A method for printing an image on a substrate, the method using the apparatus recited in claim 10, the method comprising the steps of:
1. moving a substrate proximate the chilling device;
2. chilling the substrate with the chilling device, thereby creating a chilled substrate;
3. moving the chilled substrate proximate the marking material device; and,
4. printing marking material to form at least one image on the chilled substrate via the marking material device, thereby forming a substrate with marking material.

23. The method for printing an image on a substrate recited in claim 22, wherein the chilling device comprises:
at least one vortex nozzle.

24. The method for printing an image on a substrate recited in claim 22, wherein the chilling device comprises:
a vortex nozzle array, the vortex tube array having a plurality of vortex nozzles.

25. The apparatus for printing an image on a substrate recited in claim 11, wherein said at least one vortex nozzle comprises:
a main tube;
an inlet in fluid communication with said main tube and in fluid communication with a source of compressed air;
a first outlet in fluid communication with said main tube and disposed distally from said airflow inlet;
a second outlet in fluid communication with said main tube and disposed proximate said airflow inlet; and,
a vortex spin chamber in fluid communication with said main tube and disposed between said cold airflow outlet and said hot airflow outlet.

26. The apparatus for printing an image on a substrate recited in claim 25, wherein said at least one vortex nozzle further comprises:
a control valve disposed within said main tube and proximate said hot airflow outlet, wherein said control valve is arranged to control a flow rate of hot air from said hot airflow outlet.

27. The apparatus for printing an image on a substrate recited in claim 14, wherein said air baffle comprises at least one of:
a longitudinal portion; and
an angled portion extending from said longitudinal portion.

28. The apparatus for printing an image on a substrate recited in claim 13, wherein said air knife comprises:
a plenum chamber having an inlet, said inlet in fluid communication with a source of compressed air; and,
a knife edge having a plurality of outflow apertures therein, each of said plurality of outflow apertures in fluid communication within said plenum chamber.

29. An apparatus for printing an image on a substrate, comprising:
at least one vortex nozzle having an air inlet, a first air outlet and a second air outlet, said air inlet in fluid communication with a compressed air source;
at least one marking material device operatively arranged to form images on at least one substrate; and,
a media transport system operatively arranged to move said at least one substrate past said first air outlet and to move said at least one substrate past said at least one marking material device to form images on said at least one substrate, wherein said first air outlet of said at least one vortex nozzle expels a cold air stream onto said at least one substrate as said at least one substrate moves on said media transport system.

30. The apparatus for printing an image on a substrate recited in claim 29 further comprising:
an air baffle arranged proximate said first air outlet of said at least one vortex nozzle, said air baffle operatively arranged to redirect and homogenize said cold air stream from said first air outlet onto said at least one substrate.

31. The apparatus for printing an image on a substrate recited in claim 30, wherein said air baffle redirects said cold air stream in a direction opposite of a direction said media transport system moves said at least one substrate.
